(19) United States
(12) Patent Application Publication
(10) Pub. No.: US 2026/0349142 A1
(43) Pub. Date: Nov. 5, 2026

(54) A METHOD OF AND DEVICE FOR PREDICTING WIND DATA

(71) Applicant: FNV IP B.V., Leidschendam (NL)

(72) Inventors: Ehsan ABOLFAZLI, Houston, TX (US); Natalia TASSO SIGNORELLI, Houston, TX (US); Rosemary SMITH, Houston, TX (US)

(73) Assignee: FNV IP B.V., Leidschendam (NL)

(21) Appl. No.: 19/196,548

(22) Filed: May 1, 2025

(51) Int. Cl. G01W 1/10; G01S 17/95

(52) U.S. Cl. CPC G01W 1/10; G01S 17/95

(57) ABSTRACT

A method of predicting wind data is disclosed. The method is performed by a processor and comprises the steps of: obtaining a plurality of predicted wind shear exponents using a machine learning model, and predicting wind data at needed height(s) based on the predicted wind shear exponents and available near-surface wind data at a specific height using the power law relationship. The machine learning model is trained using a training dataset comprising near-surface wind data at a first height and associated atmospheric parameters and oceanic parameters and validated using a validation dataset comprising estimated wind shear exponents, the training dataset and validation dataset being non-identical, and the estimated wind shear exponents being estimated based on a set of near-surface wind data obtained at the first height and a set of wind data obtained using a remote sensing device at a plurality of second heights, by assuming that the set of wind data at the plurality of second heights follows a power law relationship with the set of near-surface wind data at the first height. Unlocking insights from Geo-Data, the present invention further relates to improvements in sustainability and environmental developments: together we create a safe and liveable world.

### FIELD OF THE INVENTION

The present disclosure generally relates to the field of renewable energies, and more particularly to a method of and a device for predicting wind data. Unlocking insights from Geo-Data, the present invention further relates to improvements in sustainability and environmental developments: together we create a safe and liveable world.

### BACKGROUND OF THE INVENTION

With the increasing interest in and development of offshore wind farms, obtaining accurate wind speed information at hub height is critical for the accurate and safe planning, design, development, and operation of an offshore wind project. Light Detection And Ranging (LiDAR) measurements have become the industry standard method for acquisition of offshore wind profile data. Nowadays LiDAR systems can serve as a primary source of wind resource data to support all aspects of offshore wind farm development.

Until the development of LiDAR buoys, offshore wind velocity measurements were limited to those from met mast towers or from single anemometers positioned typically up to 12 m above sea level. Floating LiDARs, with its proven capability to measure at up to 11 levels, between 12 m and 300 m above the sea surface, are a more cost-effective way to acquire wind data at a variety of different heights. However, as with all measurements, they are often limited in duration and therefore need to be supplemented with hindcast data for reliable wind analyses. Wind hindcasts provide a long-term data solution and are typically well respected for their dependable wind velocities at 10 m height.

Extrapolation of the wind speed to various heights, specifically hub height, relies on wind profile laws. Commonly used wind profiles include the logarithmic profile model, the Frøya model and the power law model. The theoretical logarithmic profile uses the sea surface roughness, the Monin-Obukhov length, a friction velocity and the von Karman constant. The Frøya model is a special case of the logarithmic wind speed profile. The empirical power law uses a simpler mathematical approach of a wind shear exponent. The power law model is frequently used within the offshore wind industry and is given by the Equation 1 as

$$u = {{u}_{r} ( \frac{z}{{z}_{r}} )}^{α} \qquad ( 1 )$$

where u is wind speed at height z, uᵣ is the reference wind speed at the reference height zᵣ, and a is the power component or wind shear exponent.

Although hub height wind speed estimations using a can be a reasonable representative of the average condition of the actual values, they can lead to under- and overestimations.

One possible approach for improving such estimations is to capture the entire physics of the ocean-atmosphere interactions. The heat and momentum exchange between the ocean and the atmosphere and the largescale atmospheric and oceanic dynamics all influence the offshore wind. This makes the physics of wind profiles complicated and modelling its dynamic costly. Though more accurate estimation results can possibly be achieved, the complexity of the physics of wind profiles makes it impractical.

In consideration of the above, there is a need for an improved and simpler method for extrapolation of the wind speed to various heights based on the power law model.

### BRIEF SUMMARY OF THE INVENTION

In one aspect of the invention there is provided a method of predicting wind data, the method is performed by a processor and comprises the steps of:
obtaining a plurality of predicted wind shear exponents using a machine learning model,
wherein the machine learning model is trained using a training dataset comprising near-surface wind data at a first height and associated atmospheric parameters and oceanic parameters and validated using a validation dataset comprising estimated wind shear exponents, the training dataset and validation dataset being non-identical, and the estimated wind shear exponents being estimated based on a set of near-surface wind data obtained at the first height and a set of wind data obtained using a remote sensing device at a plurality of second heights, by assuming that the set of wind data at the plurality of second heights follows a power law relationship with the set of near-surface wind data at the first height,
wherein input to the machine learning model comprises available near-surface wind data at a specific height comprising the first height and associated atmospheric parameters and oceanic parameters;
predicting wind data at needed height(s) based on the predicted wind shear exponents and the available near-surface wind data at the specific height using the power law relationship.

The present disclosure is based on the inventors' insight that machine learning (ML) techniques together with measured LiDAR data can be used to improve the reliability of wind speeds derived for various heights, including hub height, by varying the wind shear exponent used in the power law model. Specifically, ML, as a technique for identifying patterns within datasets, is utilized in the present disclosure as a technique to aid in wind profile estimation by learning the relationship between wind shear exponents, that can give reliable wind profile estimation, and near-surface wind measurements and associated atmospheric and oceanic parameters. Wind shear exponents derived from the ML model can then used in a power law model to estimate wind speeds at various heights.

According to the method of the present disclosure, first of all, for preparing training data and validation data for training and validating the machine learning model, wind shear exponents which can be used to precisely extrapolate the wind data at different height based on the power law model, are obtained or estimated by using both near-surface wind data at a first height and wind data measured using a remote sensing device at a plurality of second heights. This is done by assuming that the wind data measured by the remote sensing device at the plurality of second heights follows the power law relationship with the near-surface wind data at the first height.

The near-surface wind data obtained at the first height, which is used to estimate the wind shear exponents, and the estimated wind shear exponents are then divided into two (or more) parts/groups. A first part of the near-surface wind data obtained at the first height, together with other associated parameters, will be used to train a machine learning model for predicting wind shear exponents, while wind shear exponents obtained based on a further part of the near-surface wind data obtained at the first height will be used to validate the trained machine learning model.

Specifically, a machine learning model is trained and used to obtain predicted wind shear exponents. The training data for the machine learning model comprises a first part of the near-surface wind data at the first height, as well as atmospheric parameters and oceanic parameters associated with the first part of near-surface wind data at the first height. Validation of the machine learning model for predicting the wind shear exponents is done based on wind shear exponents obtained based on a further part of the near-surface wind data obtained at the first height.

The thus trained machine learning model is used to capture non-linear dependencies between environmental parameters and the wind shear exponent, leading to improved generalization across varying meteorological conditions and locations. The machine learning model has learnt the relationship between the wind shear exponent and the near-surface wind measurements, atmospheric and oceanic parameters, which can be used to predict wind shear exponents based on any available near-surface wind data at the first height. The predicted wind shear exponents are then used to obtain or estimate wind data at needed height(s) based on the power law model.

The machine learning model does not rely solely on physical modeling (like traditional fixed-α power law approaches), but instead learns from complex, high-dimensional patterns in environmental data, improving predictive accuracy.

The trained machine learning model can be then conveniently used to predict wind shear exponents to be used to estimate wind data at the desired height. The method does not involve complicated analytical modeling of atmospheric dynamics, thereby enabling efficient and scalable wind profile estimation using readily available input data.

In an example of the present disclosure, the set of near-surface wind data at the first height comprises a time series of near-surface wind data.

Time series of near-surface wind data are commonly available from standard meteorological stations or offshore platforms and can be conveniently used by the method of the present disclosure without requiring specialized equipment or complex measurements. This not only improves accessibility but also ensures the model remains adaptable to real-world conditions over extended periods.

In an example of the present disclosure, the set of wind data obtained using a remote sensing device comprises a time series of wind data at the plurality of second heights, the first time series temporally correspond to the second time series.

By ensuring that the time series of near-surface wind data corresponds temporally to the time series of remote sensing data at multiple heights, the method enables accurate alignment of measurement data. This temporal correspondence allows for more precise derivation of wind shear exponents and improves the quality of the machine learning training dataset, resulting in more reliable model performance.

In an example of the present disclosure, the time series of near-surface wind data and the time series of wind data at the plurality of second heights comprise 10-minute mean wind speed.

Using 10-minute mean wind speed, as adopted by international standards such as those from the World Meteorological Organization (WMO) and widely used in the wind energy industry, ensures compatibility with most existing wind measurement systems and datasets. This facilitates data integration, reduces the need for pre-processing or resampling, and enables broader applicability of the method across various sites and monitoring platforms.

Using 10-minute mean wind speed also reduces the impact of short-term fluctuations and turbulence, providing a more stable and representative dataset for wind profile modeling. This improves the consistency of the derived wind shear exponents and enhances the robustness of the machine learning model against noisy or transient wind behavior.

In an example of the present disclosure, each wind shear exponent is estimated, for each time step of the time series, by determining a wind shear exponent which gives a best-fit to a wind profile formed by the wind data at the plurality of second heights obtained using the remote sensing device.

As can be contemplated by those skilled in the art, the wind data at the plurality of second heights defines a measured wind profile. The method of the present disclosure determines which value of wind shear exponent (α) best fits this measured profile by applying the power law model and finding the a that minimizes the difference between the predicted and measured values.

This approach ensures that the estimated a reflects the true vertical structure of the wind at that specific moment, rather than relying on a fixed or average value. It improves the accuracy of subsequent wind speed predictions and makes the model more responsive to real-time atmospheric changes.

In an example of the present disclosure, the best-fit to the wind profile is determined by deciding that a deviation between a wind profile comprising wind data derived from the near-surface wind data using the power law relationship and the wind profile formed by the wind data at plurality of second heights obtained using a remote sensing device is a below a threshold value.

In practice, for each time step, there is generated a predicted wind profile using near-surface wind data and a trial value of α via the power law. This predicted profile is then compared to an actual measured profile from remote sensing. The system evaluates the deviation (e.g., Root mean square error, RMSE, or another metric) between the two profiles and selects the a for which the deviation falls below a predefined threshold.

By using a threshold-based deviation check, this method introduces an objective and quantifiable criterion for selecting the most suitable wind shear exponent. This reduces uncertainty in the fitting process and ensures that only physically meaningful a values—those that produce an acceptably close match to real data—are used, enhancing the robustness of wind speed estimation.

In an example of the present disclosure, the atmospheric parameters comprise air temperature and optionally air pressure.

In another example of the present disclosure, the oceanic parameters comprise at least one of sea surface temperature and significant wave height.

These parameters are associated with the near surface wind data at the first height. It has been identified by the inventors that these parameters air temperature and sea surface temperature are the most impactful on the wind shear exponent (α), and thereby directly influence the accuracy of wind speed estimations at hub height. The role of air temperature, and sea surface temperature as the main parameters affecting a is likely associated with the heat and momentum exchange and the instabilities at the sea-air interface.

Empirical evaluation revealed that all combinations of training parameters which included these three variables consistently outperformed those that excluded one or more of them. Accordingly, these parameters are included in the feature set used for building and training the machine learning models, in order to enhance prediction accuracy and model robustness.

In an example of the present disclosure, the machine learning model is trained by the steps of:
inputting a set of training data comprising a part of the set of the near-surface wind data obtained at the first height and associated atmospheric parameters and oceanic parameters into the machine learning model;
training the machine learning model such that the machine learning model learns to approximate relationship between the input training data and predicted wind shear exponents.

This approach allows the model to capture non-linear dependencies between environmental parameters and the wind shear exponent, leading to improved generalization across varying meteorological conditions and locations. The machine learning model does not rely solely on physical modeling (like traditional fixed-α power law approaches), but instead learns from complex, high-dimensional patterns in environmental data, improving predictive accuracy.

It also allows for a wide variety of machine learning models (e.g., neural networks, random forests) to be applied, without being tied to a specific architecture.

In an example of the present disclosure, the machine learning model is validated by the steps of:
inputting, into the trained machine learning model, a set of test data comprising a further part of the near-surface wind data obtained at the first height and associated atmospheric parameters and oceanic parameters into the machine learning model;
running the trained machine learning model to generate predicted wind shear exponents;
validating the trained machine learning model by comparing wind speed at the second height, as estimated by wind speed at the first height and the predicted wind shear exponents, with measured wind speed at the second height.

The validation process connects data-driven machine learning output with physical modelling, that is, the power law model, and measured results (for example LiDAR wind speed), it validates whether the predicted variable actually serves its intended role in a physical estimation process. This validation process ensures that the machine learning model is not only statistically accurate in predicting wind shear exponents, but also technically effective in the context of real-world wind speed estimation using the power law model.

In an example of the present disclosure, the training dataset and validation dataset are mutually exclusive.

This ensures that no data instance is used both for training and for validating the model. This approach ensures objective evaluation of model performance and avoids overfitting. However, in alternative embodiments, partial overlap may be tolerated, for example when cross-validation or other statistical evaluation methods are employed.

In an example of the present disclosure, the plurality of predicted wind shear exponents is obtained further based on location parameters.

Incorporating location parameters, such as geographic coordinates, terrain type, or proximity to coastline, enables the machine learning model to account for site-specific environmental influences on wind shear behavior. This enhances the model's adaptability across different regions and improves accuracy by embedding local context into the prediction of wind shear exponents.

In an example of the present disclosure, the first height is in a range of 3 meters to 10 meters.

This range reflects standard measurement heights for near-surface wind speed, particularly from ground-based meteorological stations or portable sensors. This is a practical and commonly used range which helps to ensure compatibility with widely available wind measurement data, facilitating easy integration and real-world implementation of the model.

In an example of the present disclosure, the second height is in a range of about 40 meters to 300 meters.

This range covers typical hub heights of modern wind turbines, making the method highly relevant to wind energy applications. It also aligns with the vertical range of remote sensing devices like LiDAR, ensuring that the model is applicable to the operational height band of interest in wind farm planning and performance assessment.

In an example of the present disclosure, the remote sensing device comprises a LiDAR.

LiDAR provides high-resolution, accurate, and non-intrusive vertical wind measurements over a wide range of heights. Specifying LiDAR ensures that the model is trained and validated on precise, high-quality wind profile data, thereby increasing the reliability of the wind shear exponent estimation and subsequent wind speed predictions. A second aspect of the present disclosure provides a device for predicting wind data, comprising a processor arranged to perform the method according to the first aspect of the present disclosure.

A third aspect of the present disclosure provides a computer program product, comprising a computer readable storage medium storing instructions which, when executed on at least one processor, cause the at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 schematically illustrates, in a flow chart type of diagram, a method of training a machine learning model for predicting wind data according to an embodiment of the present disclosure;

FIG. 2 schematically illustrates, in a flow chart type of diagram, a method of predicting wind data, in according to an embodiment of the present disclosure; and

FIG. 3 is a diagram schematically illustrating comparison of between measured wind speed, wind speed predicted using the method of the present disclosure and wind speed predicted using a fixed wind shear exponent.

### DESCRIPTION OF ILLUSTRATIVE EMBODIMENTS

The following is a description of certain embodiments of the invention, given by way of example only and with reference to the drawings.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an embodiment in the present disclosure can be a reference to the same embodiment or any other embodiment. Such references thus relate to at least one of the embodiments herein.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For the purposes of the present disclosure, the term “wind data” is primarily intended to refer to wind speed measurements, unless otherwise specified.

In the present disclosure, the term “near-surface wind data” generally refers to wind measurements taken at relatively low altitudes above ground or sea level, typically within the range of 3 to 10 meters. These measurements are commonly collected using meteorological masts, offshore buoys, or other ground-based sensors.

In the context of the present disclosure, near-surface wind data serves as a primary input for predicting wind conditions at elevated heights using a power law model in combination with machine learning techniques.

In the present disclosure, the term “hub height” refers to the height above ground or sea level at which the central axis (hub) of a wind turbine's rotor is located. Modern utility-scale wind turbines typically have hub heights ranging from approximately 60 to 160 meters, with offshore turbines sometimes exceeding 200 meters.

Hub height is a critical reference point in wind energy modelling and forecasting, as the wind speed at this height directly affects turbine performance and energy yield. An application of the present disclosure can relate to accurately estimating wind speed at or near hub height using data collected at lower elevations.

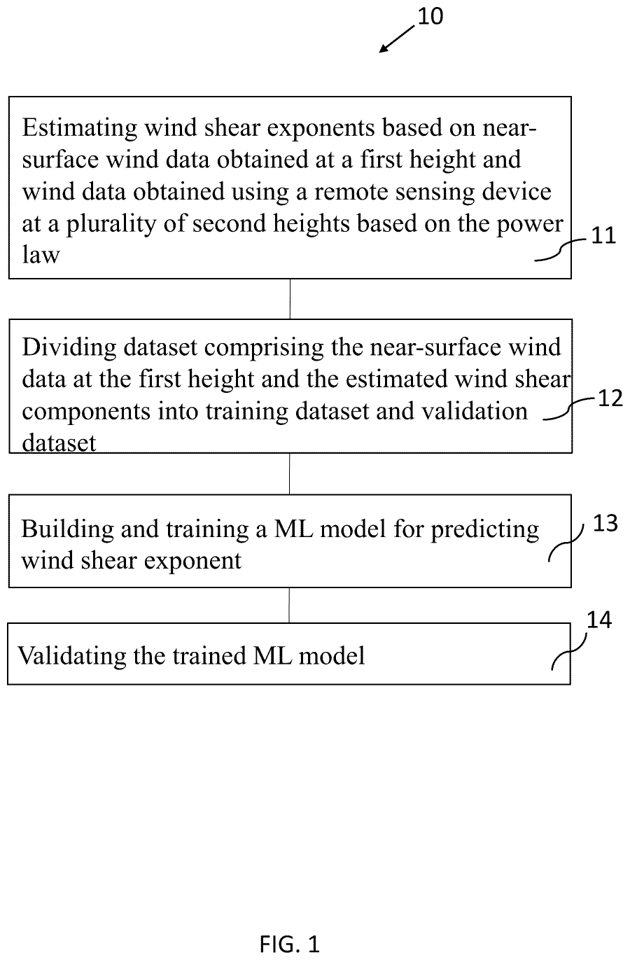

Referring to FIG. 1, a method 10 of training a machine learning model for predicting wind data according to an example of the present disclosure is schematically illustrated in a flow chart type of diagram.

At step 11, a plurality of wind shear exponents is estimated based on a set of near-surface wind data obtained at a first height and a set of wind data obtained using a remote sensing device at a plurality of second heights based on the power law model as described in the background section.

In preparation of this step, near-surface wind data and measured wind data obtained by a remote sensing device are collected or complied.

As can be understood by those skilled in the art, near-surface wind data as used in the present disclosure generally refers to wind speed measured close to the Earth's surface, typically at about 3 to 10 meters above ground level (AGL), which is the standard height for meteorological wind measurements, as defined by the World Meteorological Organization (WMO). Near-surface wind data can be measured using an anemometer placed on meteorological towers, weather stations, or buoys (over water bodies).

In the present disclosure, the near-surface wind data can comprise wind speed measured at a first height, such as at 4 meter, 10 meter, or at similar height, for example from 4 to 10 meter, which are commonly used in the industry to obtain wind speed close to the Earth's surface.

In the meantime, wind speed measured by a remote sensing device are obtained at a plurality of second heights. The second height can comprise the so-called hub height, which can be 140 meters for example. In the present disclosure, the second height can be any height in the range of 40 to 300 meters.

The remote sensing device used to measure the wind speed can be an optical, acoustic or radar-based device, such as for example a LiDAR, Sonic Detection and Ranging (SoDAR) or a radar-based wind profiler.

In the present disclosure, the wind measurements, including both the near-surface wind data and the LiDAR data, comprise 10-min mean wind speed values. It can be understood by those skilled in the art that similar results can be expected, using either a 1-hr mean or 1-min mean.

In an example, the near-surface wind data and LiDAR wind data used can be over a period of between 1 and 4 years or a longer period. The near-surface wind data can comprise a first time series of 10-min wind speed at 4 meter over one year, and the LiDAR wind data can comprise a second time series of 10-min wind speed a group of heights of for example 100 m, 110 m, . . . , 160 m, over the same period. As can be contemplated by those skilled in the art, the first time series temporally correspond to the second time series, that is, the first and second time series are temporally aligned to each other.

In preparing the wind data, any timestamp that contained missing data in any of training parameters to be used, including oceanic and atmospheric parameters, or wind speeds at different heights were omitted from all of the time series. This ensures data integrity and prevents the introduction of bias or noise during the machine learning training and validation processes.

Table 1 shows exemplary near-surface wind data and associated environment parameters. Here Dirym and SPEEDym, relate to the direction and speed at a distance of y m above the sea or ground surface, respectively.

TABLE 1
Exemplary near-surface wind data and associated environment parameters

| | DIR4 m | AirPres | AirTemp | SurfTemp | SPEED4 m |
|---|---|---|---|---|---|
| DATE/TIME | [Degrees] | [Pa] | [C] | [C] | [m/s] |
| 29-Dec-2019 15:20:00 | 66 | 1024.02 | 8.79 | 8.54 | 3.66 |
| 29-Dec-2019 15:30:00 | 72 | 1023.54 | 8.9 | 8.56 | 3.99 |
| 29-Dec-2019 15:40:00 | 69 | 1023.44 | 8.9 | 8.56 | 5.02 |
| 29-Dec-2019 15:50:00 | 76 | 1023.24 | 9.01 | 8.56 | 4.75 |
| 29-Dec-2019 16:00:00 | 83 | 1023.24 | 9.01 | 8.56 | 4.57 |
| 29-Dec-2019 16:10:00 | 84 | 1023.34 | 9.01 | 8.57 | 4.03 |
| 29-Dec-2019 16:20:00 | 84 | 1023.44 | 9.01 | 8.57 | 3.32 |
| 29-Dec-2019 16:30:00 | 84 | 1023.24 | 9.01 | 8.57 | 3.07 |
| 29-Dec-2019 16:40:00 | 78 | 1022.85 | 9.01 | 8.58 | 2.96 |

Table 2 shows exemplary wind measurement data obtained using LiDAR for the same time period as in Table 1.

TABLE 2
wind measurement data obtained using LiDAR for the same time period as in Table 1

| | SPEED40 m | SPEED60 m | SPEED80 m | SPEED100 m | SPEED120 m |
|---|---|---|---|---|---|
| DATE/TIME | [m/s] | [m/s] | [m/s] | [m/s] | [m/s] |
| 29-Dec-2019 15:20:00 | 5.08 | 5.23 | 5.4 | 5.22 | 5.11 |
| 29-Dec-2019 15:30:00 | 6.19 | 6.39 | 6.48 | 6.45 | 6.32 |
| 29-Dec-2019 15:40:00 | 6.34 | 6.61 | 6.64 | 6.64 | 6.76 |
| 29-Dec-2019 15:50:00 | 6.17 | 6.53 | 6.59 | 6.84 | 6.83 |
| 29-Dec-2019 16:00:00 | 5.52 | 5.78 | 6.21 | 6.36 | 6.48 |
| 29-Dec-2019 16:10:00 | 4.61 | 5.07 | 5.24 | 5.52 | 5.66 |
| 29-Dec-2019 16:20:00 | 4.2 | 4.47 | 4.64 | 4.7 | 4.82 |
| 29-Dec-2019 16:30:00 | 4.02 | 4.27 | 4.55 | 4.59 | 4.69 |
| 29-Dec-2019 16:40:00 | 4.68 | 4.81 | 4.85 | 4.99 | 5.38 |

Wind shear exponents are then estimated based on the above prepared near-surface wind data at the first height and wind data obtained using the remote sensing device at multiple second heights and using the power law model of Equation (1).

Specifically, at each time step, a is estimated by finding the best fit to the entire measured wind profile given by Equation 1. That is, a wind shear exponent at a time step is determined as the one giving a best-fit to a wind profile formed by the wind data at the plurality of second heights obtained using the remote sensing device.

To do this, at each time step of the time series, a wind profile is constructed using the wind speed measurements at a plurality of second heights obtained from the remote sensing device (e.g., LiDAR). The wind shear exponent (α) is then estimated by applying a curve-fitting or regression technique to determine the value of α that minimizes the error between the measured wind speeds and the wind speeds predicted by the power law model across those heights. This best-fit a represents the exponent that most accurately describes the vertical wind profile at that particular time.

The estimation of the wind shear exponent a by, for example, fitting a power law curve to a measured wind profile is known to those skilled in the art and will not be elaborated here.

In determining the wind shear exponent that gives the best-fit to the wind profile measured by the remote sensing device, a threshold value can be used. When the deviation between the wind profile estimated from the power law model and the wind profile measured by the remote sensing device is below the threshold value, the estimated wind shear exponent is considered as the one give the best fit to the measured wind profile.

The above-described procedure is used to derive or estimate wind shear exponents for all the time steps in the whole period under study. Besides, atmospheric and oceanic parameters are collected for the same periods. The atmospheric parameters can comprise air temperature and air pressure, while the oceanic parameters can comprise sea surface temperature and optionally significant wave height. It is learnt through study that, together with the near-surface wind speed, the air temperature and the sea surface temperature have the most impact on the performance of the machine learning model for predicting the wind shear exponent used in the present disclosure.

Other parameters that can be considered include for example wind direction at the first heigh and significant wave height.

At step 12, the near-surface wind data at the first height, along with the associated wind shear exponents derived therefrom, are divided into two or more subsets, including a training dataset and a validation dataset. The training dataset comprises a first subset of the near-surface wind data, together with corresponding atmospheric and oceanic parameters, and is used to train the machine learning model to predict the wind shear exponent. The validation dataset comprises a second subset of the data, including wind shear exponents that are not used during training, and is used to validate the performance and generalization capability of the trained machine learning model.

This separation helps prevent overfitting and enables an objective evaluation of the model's predictive accuracy when applied to new or unseen environmental conditions. In some embodiments, the training and validation datasets may be split chronologically or randomly, depending on the nature of the time series data and desired application.

In an example, the training dataset and the validation dataset are selected to be non-identical, and preferably selected such that no data sample used in training is included in the validation set. This separation allows the validation results to reflect the generalization performance of the machine learning model, ensuring that the validation process provides an unbiased measure of model performance.

In some alternative embodiments, a small degree of overlap may be tolerated, for example when using cross-validation or in cases with limited data availability.

According to the present disclosure, machine learning is used to estimate a temporally variable wind shear exponent a for vertical extrapolation of for example offshore wind profiles. The training and validation of the machine learning model in according to the present disclosure will be described in the following at steps 13 and 14.

At step 13, a machine learning model for predicting wind shear exponent is built and trained.

In certain embodiments, the machine learning model comprises a random forest regression model or an artificial neural network model. These models are trained using measured environmental parameters to learn the relationship with the wind shear exponent a with these environmental parameters.

As an example, the machine learning model is implemented as a random forest regression (RFR) model. The RFR model builds an ensemble of decision trees, each trained on a random subset of the training data and input features, such as near-surface wind speed, air temperature, sea surface temperature, and wave height. The final predicted wind shear exponent a is obtained by averaging the outputs of all individual trees. This ensemble-based approach improves prediction accuracy and reduces overfitting, while also allowing analysis of feature importance to understand which environmental parameters most influence a.

In a specific example of the present disclosure, the machine learning model used to predict the wind shear exponent (α) is implemented as an artificial neural network (ANN). The ANN is configured to approximate the complex, non-linear relationship between environmental input parameters and the resulting wind shear exponent values, based on training from historical data.

The ANN comprises a set of interconnected processing units (neurons) organized into multiple layers, including: an input layer configured to receive a plurality of input features; one or more hidden layers comprising neurons with activation functions to model non-linear interactions; and an output layer configured to produce a predicted scalar value corresponding to the wind shear exponent a.

The input features may include, but are not limited to: near-surface wind speed measurements at a reference height (e.g., 4-10 meters), atmospheric parameters such as air temperature and optionally air pressure, oceanic parameters such as sea surface temperature and optionally significant wave height. Optionally, location parameters such as geographic coordinates, terrain classification, or distance from coastline may also be used as input features.

Each neuron in the hidden layers receives weighted inputs from the previous layer and applies an activation function, such as ReLU (Rectified Linear Unit), sigmoid, or tanh, to compute an output. The network is trained using a dataset in which wind shear exponents have been derived from measured wind profiles (e.g., from LiDAR measurements at multiple heights), corresponding to the same timestamps and environmental conditions as the input data.

During training, the ANN adjusts the connection weights between neurons using a supervised learning algorithm, such as stochastic gradient descent (SGD) or Adam optimizer, to minimize a loss function. The loss function may be, for example, mean squared error (MSE) between the predicted α and the a derived from measured wind profiles.

In one embodiment, the ANN comprises:
An input layer with N neurons, where N corresponds to the number of input features;
Two or more hidden layers, each comprising between 16 and 128 neurons, depending on the complexity of the feature space;
An output layer with a single neuron, representing the predicted α.

To enhance generalization and avoid overfitting, regularization techniques such as dropout, L2 weight decay, or early stopping may be applied. In some embodiments, the training dataset is normalized or standardized to improve convergence.

Once the artificial neural network model has been trained using historical input-output data pairs (i.e., environmental parameters and corresponding derived wind shear exponents), the model is subjected, at step 14, to a validation process to ensure its predictive accuracy and practical reliability in real-world wind estimation tasks.

The validation is carried out using the validation dataset comprising time series data that were not used during the training phase.

During the validation process, the trained ANN model receives test input features (e.g., near-surface wind speed, environmental parameters) at each time step. For each time step, the ANN outputs a predicted value of the wind shear exponent apred.

The predicted α_{pred} is then used, in combination with the near-surface wind speed, to estimate wind speed at a higher target height, using the power law model. The estimated wind speed is compared against the measured wind speed from LiDAR or other remote sensing data.

The difference between predicted and measured wind speeds is quantified using standard regression error metrics, such as: Mean Absolute Error (MAE), Root Mean Square Error (RMSE), Coefficient of Determination (R2). Practically, a prediction is considered acceptable if the deviation between the measured wind speed and the estimated wind speed is below a predetermined error threshold, ensuring robustness.

The validation process verifies that the ANN-predicted wind shear exponents, when applied within a power law framework, produce wind speed estimates that closely match actual measured wind speeds at various heights, thereby confirming the model's effectiveness in wind profile reconstruction.

It will be understood by those skilled in the art that the above example is described for illustrative purpose only. The present disclosure can be implemented using any machine learning model suitable for learning relationships between environmental input parameters and wind shear exponents, including but not limited to regression models, ensemble methods, neural networks, or other data-driven approaches.

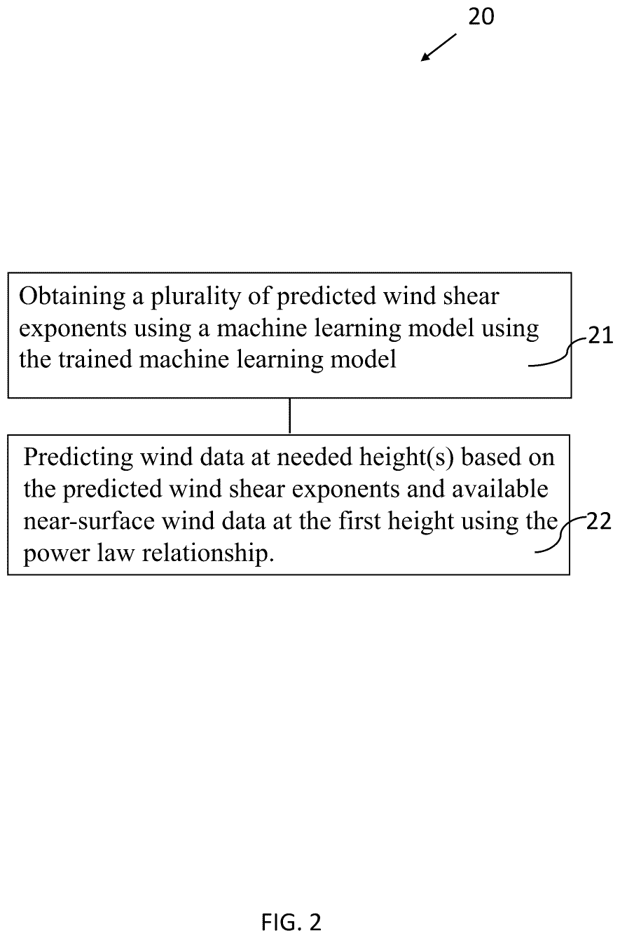

FIG. 2 schematically illustrates, in a flow chart type of diagram, a method of predicting wind data, in according to an embodiment of the present disclosure.

The thus trained and validated machine learning model is used, at step 21, to obtain a plurality of predicted wind shear exponents. The input to the machine learning model comprises near-surface wind data at a specific height including the first height, at the needed location and period, as well as associated oceanic and atmospheric parameters.

In an embodiment of the present disclosure, the near-surface wind speed used as input to the machine learning model is measured at a specific reference height, such as 4 meters. To ensure consistency between training and prediction, it is preferable that the wind speed used during prediction is measured at the same height as that used during model training.

It is noted that conventional supervised learning models assume that input features at inference time follow the same distribution as those used during training. Therefore, changes in the measurement height of near-surface wind data, which is input to the trained model to predict wind shear component, may introduce distribution shift, potentially reducing the accuracy of the predicted wind shear exponent unless appropriately accounted for in the model design.

If wind speed data at different heights (e.g., 3 to 10 meters) are to be used, the model may be trained to incorporate the measurement height as an additional input feature, or multiple heights may be included in the training data to enhance the model's generalization capability.

In practice, even if the machine learning model was trained using wind speed measured at a specific reference height (e.g., 4 meters), it may still produce reasonably accurate predictions of the wind shear exponent a when the input wind speed is measured at a slightly different height, such as within a range of 3 to 6 meters. This is because the predicted α reflects the characteristics of the overall wind profile, which tend to vary smoothly over small height differences near the surface.

At step 22, the predicted wind shear exponents are used to predict wind data at the needed height(s) based on the near-surface wind data at the specific height, and using the power law model. The procedure is well known to those skilled in the art and will not be elaborated here.

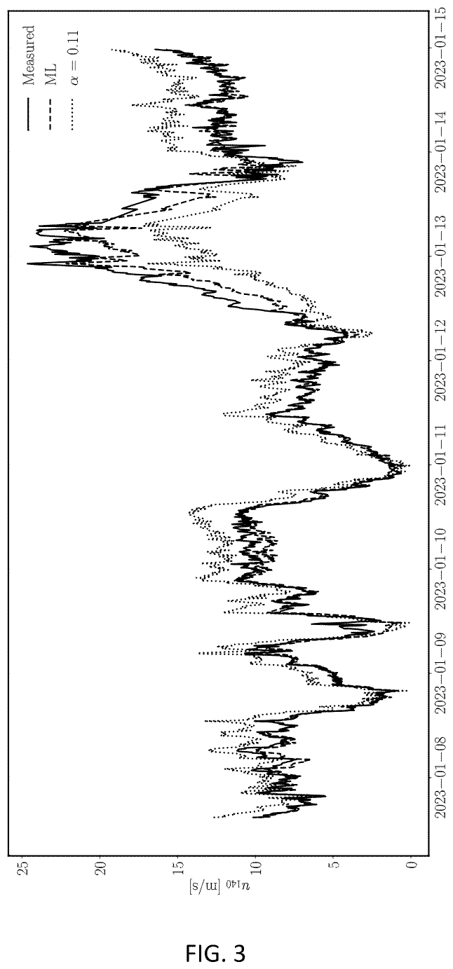

FIG. 3 is a diagram schematically illustrating comparison of between measured wind speed, wind speed predicted using the method of the present disclosure and wind speed predicted using a fixed wind shear exponent, each at a distance of 140 m above the sea surface.

FIG. 3 shows results from 8 Jan. 2023 to 15 Jan. 2023. In FIG. 3, the solid line indicates wind speed measured using LiDAR, the dashed line shows wind speed predicted using the ML model of the present disclosure, and the dotted line shows wind speed obtained using a constant wind shear exponent.

Results in FIG. 3 shows improvements in hub height wind speeds compared to those estimated using a constant α (within the 0.11-0.14 range) in the power law model. For instance, hub height wind speed estimations using α=0.11 lead to over- and underestimations in hub height wind speed compared to those using the method of the present disclosure. It can be seen from FIG. 3 that the wind data as predicted using the ML of the present disclosure conforms to the measured wind data much better than the wind data predicted using a constant α.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

1. A method of predicting wind data, the method comprising:
obtaining a plurality of predicted wind shear exponents using a machine learning model,
wherein the machine learning model is trained using a training dataset comprising near-surface wind data at a first height and associated atmospheric parameters and oceanic parameters and validated using a validation dataset comprising estimated wind shear exponents, the training dataset and validation dataset being non-identical, and the estimated wind shear exponents being estimated based on a set of near-surface wind data obtained at the first height and a set of wind data obtained using a remote sensing device at a plurality of second heights, by assuming that the set of wind data at the plurality of second heights follows a power law relationship with the set of near-surface wind data at the first height,
wherein input to the machine learning model comprises available near-surface wind data at a specific height comprising the first height and the associated atmospheric parameters and the oceanic parameters;
predicting wind data at one or more height based on the predicted wind shear exponents and the available near-surface wind data at the one or more heights using the power law relationship.

2. The method according to claim 1, wherein the set of near-surface wind data at the first height comprises a time series of near-surface wind data.

3. The method according to claim 2, wherein the set of wind data obtained using a remote sensing device comprises a time series of wind data at the plurality of second heights, a first time series temporally correspond to a second time series.

4. The method according to claim 3, wherein the time series of near-surface wind data and the time series of wind data at the plurality of second heights comprise 10-minute mean wind speed.

5. The method according to claim 3, wherein each wind shear exponent is estimated, for each time step of the time series, by determining a wind shear exponent which gives a best-fit to a wind profile formed by the wind data at the plurality of second heights obtained using the remote sensing device.

6. The method according to claim 5, wherein the best-fit to the wind profile is determined by deciding that a deviation between the wind profile comprising the wind data derived from the near-surface wind data using the power law relationship and the wind profile formed by the wind data at the plurality of second heights obtained using the remote sensing device is a below a threshold value.

7. The method according to claim 1, wherein the associated atmospheric parameters comprise air temperature and optionally air pressure.

8. The method according to claim 1, wherein the oceanic parameters comprise sea surface temperature and optionally significant wave height.

9. The method according to claim 1, further comprising:
inputting a set of training data comprising a part of the set of the near-surface wind data obtained at the first height and associated atmospheric parameters and oceanic parameters into the machine learning model;
training the machine learning model such that the machine learning model learns to approximate relationship between the input training data and predicted wind shear exponents.

10. The method according to claim 9, further comprising:
inputting, into the trained machine learning model, a set of test data comprising a further part of the near-surface wind data obtained at the first height and associated atmospheric parameters and oceanic parameters into the machine learning model;
running the trained machine learning model to generate predicted wind shear exponents;
validating the trained machine learning model by comparing wind speed at the second height, as estimated by wind speed at the first height and the predicted wind shear exponents, with measured wind speed at the second height.

11. The method according to claim 1, wherein the training dataset and validation dataset are mutually exclusive.

12. The method according to claim 1, wherein the plurality of predicted wind shear exponents is obtained further based on location parameters.

13. The method according to claim 1, wherein the first height is in a range of 3 meters to 10 meters.

14. The method according to claim 1, wherein the plurality of second heights are in a range of about 40 meters to 300 meters.

15. The method according to claim 1, wherein the remote sensing device comprises a LiDAR.

16. A device for predicting wind data, the device comprising:
at least one processor;
at least one memory storing instructions, which when executed by the at least one processor, cause the device to:
obtain a plurality of predicted wind shear exponents using a machine learning model,
wherein the machine learning model is trained using a training dataset comprising near-surface wind data at a first height and associated atmospheric parameters and oceanic parameters and validated using a validation dataset comprising estimated wind shear exponents, the training dataset and validation dataset being non-identical, and the estimated wind shear exponents being estimated based on a set of near-surface wind data obtained at the first height and a set of wind data obtained using a remote sensing device at a plurality of second heights, by assuming that the set of wind data at the plurality of second heights follows a power law relationship with the set of near-surface wind data at the first height,
wherein input to the machine learning model comprises available near-surface wind data at a specific height comprising the first height and associated atmospheric parameters and oceanic parameters;
predict wind data at one or more heights based on the predicted wind shear exponents and the available near-surface wind data at the one or more heights using the power law relationship.

17. (canceled)

18. The device according to claim 16, wherein the set of near-surface wind data at the first height comprises a time series of near-surface wind data.

19. The device according to claim 18, wherein the set of wind data obtained using a remote sensing device comprises a time series of wind data at the plurality of second heights, a first time series temporally correspond to a second time series.

20. The device according to claim 19, wherein the time series of near-surface wind data and the time series of wind data at the plurality of second heights comprise 10-minute mean wind speed.

21. The device according to claim 19, wherein each wind shear exponent is estimated, for each time step of the time series, by determining a wind shear exponent which gives a best-fit to a wind profile formed by the wind data at the plurality of second heights obtained using the remote sensing device.
